(19) United States
(12) Patent Application Publication
(10) Pub. No.: US 2018/0213204 A1
(43) Pub. Date: Jul. 26, 2018

(54) VIDEO DELIVERY DEVICE, VIDEO DELIVERY SYSTEM, AND VIDEO DELIVERY METHOD

(71) Applicant: MITSUBISHI ELECTRIC CORPORATION, Tokyo (JP)

(72) Inventors: Yasunori HOSHIHARA, Tokyo (JP); Kiyotaka KATO, Tokyo (JP)

(73) Assignee: MITSUBISHI ELECTRIC CORPORATION, Tokyo (JP)

(21) Appl. No.: 15/744,433

(22) PCT Filed: Oct. 22, 2015
(86) PCT No.: PCT/JP2015/079804

§ 371 Date: Jan. 12, 2018

(51) Int. Cl. H04N 13/00; H04N 21/61; H04N 21/236; H04N 21/647

(52) U.S. Cl. CPC H04N 13/0059; H04N 21/6156; H04N 21/6473; H04N 21/236; H04N 21/6106

(57) ABSTRACT

A video delivery device includes a transmitting/receiving unit for transmitting/receiving a 2D or 3D video signal to/from one or more display devices connected via a ring network. The transmitting/receiving unit includes an UL transmitting unit and an UL receiving unit for transmitting and receiving a video signal via an uplink of the ring network, and a DL transmitting unit and a DL receiving unit for transmitting and receiving a video signal via a downlink. For transmitting/receiving a 2D video signal, the DL transmitting unit and the DL receiving unit transmit and receive the 2D video signal. For transmitting/receiving a 3D video signal, the DL transmitting unit and the DL receiving unit transmit and receive a left-eye video signal, and the UL transmitting unit and the UL receiving unit transmit and receive a right-eye video signal.

### TECHNICAL FIELD

The present invention relates to a video delivery device for delivering two-dimensional (2D) video and three-dimensional (3D) video to display devices, a video delivery system including the display devices and the video delivery device, and a method for delivering 2D video and 3D video to a display device.

### BACKGROUND ART

In recent years, with the advances in video processing technologies, the resolution of video is becoming higher. While full high definition televisions, which are prevalent televisions in the households, have a resolution of 2K (1920×1080 pixels), 4K televisions with four times higher resolution have already started to be put to practical use, and even 8K televisions with 16 times higher resolution will soon be put to practical use. In addition, not only 2D video of the conventional art but also stereoscopic video, that is, 3D video has been widely used. For display of 3D video, independent video for each of the right eye and the left eye is required in principle, and thus twice the amount of 2D video information is required.

As video becomes higher in resolution and more sophisticated, the amount of information used for delivery of video is increased dramatically. Thus, the capacity and the quality of video transmission paths also need to be improved.

Furthermore, there are a variety of video delivery systems for delivery and display of video to and on a plurality of display devices. In a vehicle, for example, a display device for a meter is provided at the driver's seat, a display device for a navigation system is provided at a central area of the front seats, and a display device for a rear seat entertainment (RSE) system is provided at the rear seats. Video distribution methods for the display devices may use a standard such as high-definition multimedia interface (HDMI) (registered trademark), include serialization of parallel RGB video information, or include compression coding of video signals.

For diversified video delivery systems in which the amount of information of video has been increased as described above, there are demands for increasing the efficiency and the speed of transmission paths, and such methods as described below have been proposed.

For example, a transmission system according to Patent Literature 1 transmits a plurality of different 2D video signals via one HDMI (registered trademark) cable by using 3D video signal transmission format of the HDMI (registered trademark) standard.

For example, a transmission device according to Patent Literature 2 inserts advance information notifying of switching between 2D video and 3D video into a multiplexed stream including 2D video signals and 3D video signals in a time-sharing manner before transmission to a reception device. The reception device receives the multiplexed stream from the transmission device, and controls the timing for switching between 2D video display and 3D video display of shutter glasses on the basis of the advance information.

### CITATION LIST

### Patent Literature

Patent Literature 1: JP 2012-49933 A

Patent Literature 2: JP 2012-129827 A

### SUMMARY OF INVENTION

### Technical Problem

According to Patent Literature 1, since two kinds of 2D video signals can be transmitted instead of one set of right-eye and left-eye 3D video signals, the efficiency of the transmission paths can be increased. The transmission system disclosed in Patent Literature 1 is, however, disadvantageous in that 3D video signals cannot be transmitted while a plurality of 2D video signals are transmitted.

According to Patent Literature 2, a stream in which 3D video signals and 2D video signals are present can be transmitted. The transmission device of Patent Literature 2, however, is disadvantageous in that video signals cannot be delivered to a plurality of display devices.

The present invention has been made to solve such problems as describe above, and an object thereof is to improve the transmission efficiency and the transmission rate in delivery of two-dimensional and three-dimensional video signals to one or more display devices.

### Solution to Problem

A video delivery device according to the present invention includes: a video acquiring/generating unit for acquiring or generating a two-dimensional or three-dimensional video signal; and a transmitting/receiving unit for transmitting and receiving the video signal to/from one or more display devices connected via a ring network, wherein the transmitting/receiving unit includes an uplink transmitting/receiving unit for transmitting and receiving a video signal via an uplink of the ring network and a downlink transmitting/receiving unit for transmitting and receiving a video signal via a downlink of the ring network, for transmitting/receiving a two-dimensional video signal, the transmitting/receiving unit transmits/receives the two-dimensional video signal via either one or both of the uplink transmitting/receiving unit and the downlink transmitting/receiving unit, and for transmitting/receiving a three-dimensional video signal, the transmitting/receiving unit transmits/receives a right-eye video signal via any one of the uplink transmitting/receiving unit or the downlink transmitting/receiving unit, and transmits/receives a left-eye video signal via another one of the uplink transmitting/receiving unit or the downlink transmitting/receiving unit.

### Advantageous Effects of Invention

According to the present invention, for transmitting/receiving a two-dimensional video signal to/from one or more display devices connected via a ring network, either one or both of the uplink transmitting/receiving unit and the downlink transmitting/receiving unit transmit/receive the two-dimensional video signal and for transmitting/receiving three-dimensional video signal, either one of the uplink transmitting/receiving unit and the downlink transmitting/receiving unit transmits/receives a right-eye video signal and the other thereof transmits/receives a left-eye video signal, which improves the transmission efficiency and the transmission rate in delivery of the two-dimensional or three-dimensional video signal to one or more display devices.

### BRIEF DESCRIPTION OF DRAWINGS

FIG. 1 is a block diagram illustrating an example configuration of a video delivery system according to a first embodiment of the present invention.

FIG. 2 is a chart explaining an example of packets delivered by a video delivery device according to the first embodiment.

FIG. 3 is a chart explaining another example of packets delivered by the video delivery device according to the first embodiment.

FIG. 4 is a block diagram illustrating an example configuration of a display device according to the first embodiment.

FIG. 5 is a flowchart illustrating operation of the video delivery device according to the first embodiment.

FIG. 6 is a block diagram illustrating an example configuration of a video delivery system according to a second embodiment of the present invention.

FIG. 7 is a hardware configuration diagram of the video delivery device according to the embodiments of the present invention.

FIG. 8 is a hardware configuration diagram of the video delivery device according to the embodiments of the present invention.

### DESCRIPTION OF EMBODIMENTS

Embodiments for carrying out the invention will now be described with reference to accompanying drawings for more detailed explanation of the invention. First Embodiment.

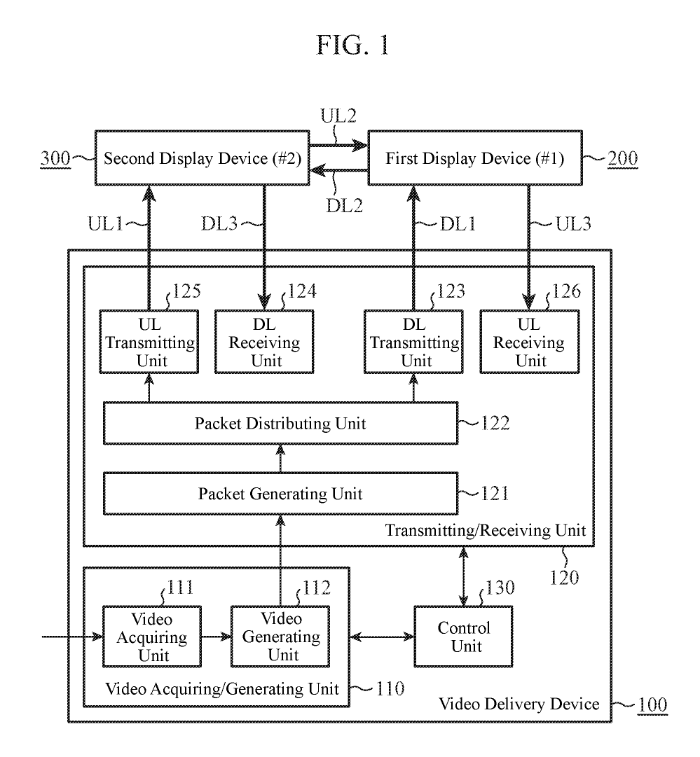

FIG. 1 is a block diagram illustrating an example configuration of a video delivery system according to a first embodiment of the present invention. The video delivery system includes a video delivery device 100, and one or more display devices in wired connection with the video delivery device 100 via a ring network.

Although two display devices, which are a first display device 200 and a second display device 300, are connected with the video delivery device 100 in the example of FIG. 1, the number of connected display devices may be one or three or larger. In this ring network, a transmission path through which video signals are transmitted from the video delivery device 100 to the first display device 200, and then to the second display device 300 will be referred to as a downlink (hereinafter, DL), and a transmission path through which video signals are transmitted from the video delivery device 100 to the second display device 300 and then to first display device 200 will be referred to as an uplink (hereinafter, UL).

In addition, transmission paths between the video delivery device 100 and the first display device 200 will be referred to as DL1 and UL3, transmission paths between the first display device 200 and the second display device 300 will be referred to as DL2 and UL2, and transmission paths between the second display device 300 and the video delivery device 100 will be referred to as DL3 and UL1. The use of the ring network as the network topology of the display device allows the total length of the transmission paths to be shorter than that in a case where another topology such as a star network is used. Thus, this reduces the total length of cables and reduces the cost for the transmission paths. In addition, the use of the ring network allows improvement in the transmission efficiency and the transmission rate in delivery of 2D and 3D video signals to one or more display devices which will be described later.

The video delivery device 100 delivers video signals to the first display device 200 and the second display device 300 connected via the ring network. The video delivery device 100 includes a video acquiring/generating unit 110 for acquiring or generating 2D video signals or 3D video signals, a transmitting/receiving unit 120 for transmitting or receiving video signals to/from the first display device 200 and the second display device 300, and a control unit 130 for controlling the video acquiring/generating unit 110 and the transmitting/receiving unit 120.

The video acquiring/generating unit 110 includes at least one of a video acquiring unit 111 and a video generating unit 112. The video acquiring unit 111 acquires 2D video signals or 3D video signals from an external device. A 3D video signal includes a right-eye signal and a left-eye signal.

The video generating unit 112 has a graphics function, a video decoding function, or the like, and generates 2D video signals or 3D video signals. In addition, the video generating unit 112 converts a 2D video signal acquired by the video acquiring unit 111 into a 3D video signal, converts, reversely, a 3D video signal into a 2D video signal, and converts the resolution of a video signal according to that of a display device. Furthermore, in order to display different video on the first display device 200 and the second display device 300, the video generating unit 112 can output a plurality of kinds of video signals at the same time. Video signals output by the video generating unit 112 are input to the transmitting/receiving unit 120.

The video acquiring/generating unit 110 also acquires or generates video signals under the control of the control unit 130, and informs the control unit 130 of information about the kinds of video signals.

When no video generating unit 112 is provided, the video acquiring unit 111 outputs video signals to the transmitting/receiving unit 120, and informs the control unit 130 of information about the kinds of video signals.

The transmitting/receiving unit 120 includes a packet generating unit 121, a packet distributing unit 122, a DL transmitting unit 123, a DL receiving unit 124, an UL transmitting unit 125, and an UL receiving unit 126.

The DL transmitting unit 123 and the DL receiving unit 124 are transmitting/receiving units for the downlink, and the UL transmitting unit 125 and the UL receiving unit 126 are transmitting/receiving units for the uplink.

The packet generating unit 121 receives video signals from the video acquiring/generating unit 110, and generates packets to be delivered to the first display device 200 and second display device 300. The packet distributing unit 122 receives the packets from the packet generating unit 121 and distributes the packets to the DL transmitting unit 123 and the UL transmitting unit 125. The DL transmitting unit 123 outputs the packets received from the packet distributing unit 122 to DL1, DL2, and DL3, which are downlink transmission paths, to deliver the packets to the first display device 200 and the second display device 300. The DL receiving unit 124 receives the packets transmitted via DL1, DL2, and DL3. The UL transmitting unit 125 outputs the packets received from the packet distributing unit 122 to UL1, UL2, and UL3, which are uplink transmission paths, to deliver the packets the second display device 300 and the first display device 200. The UL receiving unit 126 receives the packets transmitted via UL1, UL2, and UL3.

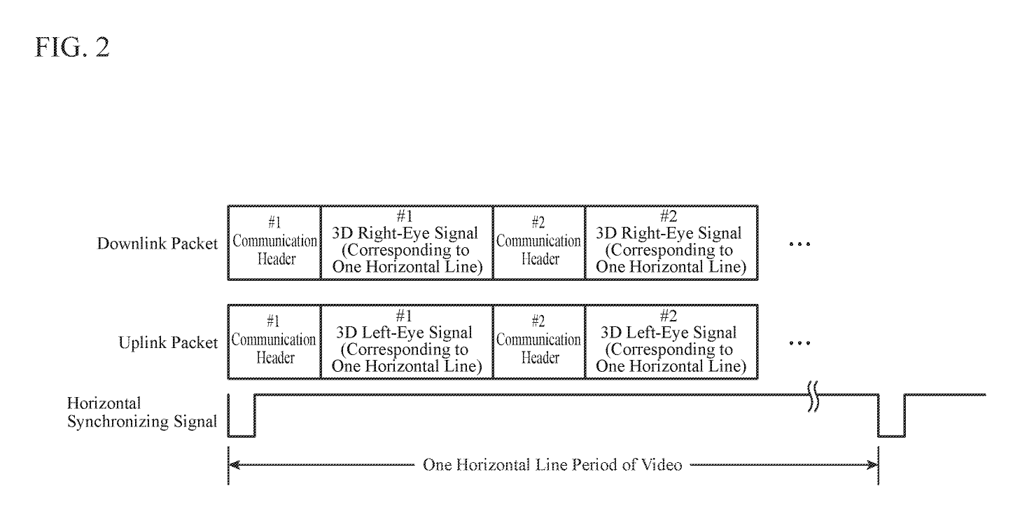

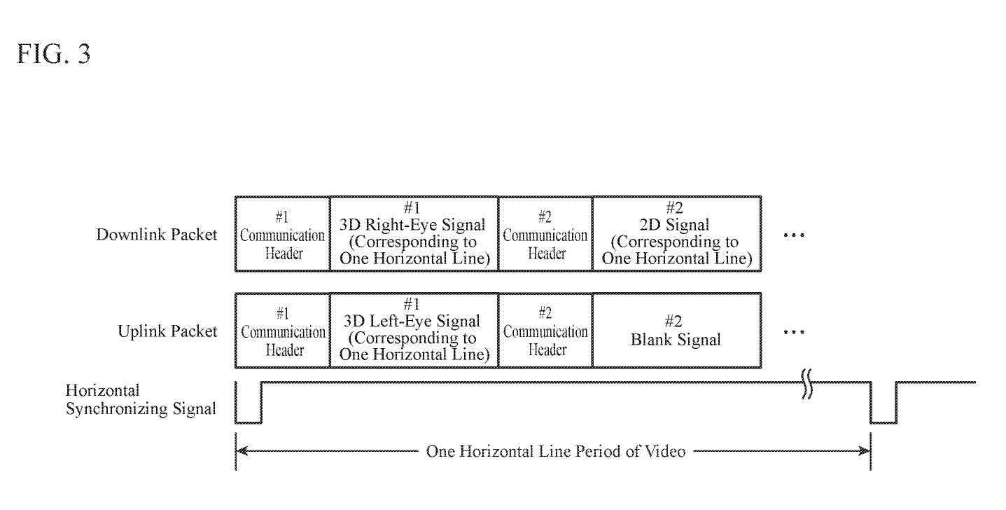

FIGS. 2 and 3 are charts explaining examples of packets delivered by the video delivery device 100. “#1” is identification information representing the first display device 200, and “#2” is identification information representing the second display device 300. One horizontal line period of video is a period during which the first display device 200 and the second display device 300 display video signals corresponding to one line in the horizontal direction and is in synchronization with a horizontal synchronizing signal generated by the control unit 130.

The packet generating unit 121 packetizes video signals corresponding to one horizontal line to be displayed on the first display device 200 and the second display device 300 during one horizontal line period of video among the video signals received from the video acquiring unit 111. In addition, the packet generating unit 121 adds a communication header to each of the video signals corresponding to one horizontal line and packetizes the video signals, so that, upon the reception of the packets, each of the first display device 200 and the second display device 300 can determine whether or not the packets are addressed to itself

A communication header contains information such as a frame type, a video type, an effective data amount, and an error detection code, for example, and information on the source of the communication header is notified from the control unit 130 to the packet generating unit 121.

A frame type is information indicating which display device the packet is addressed to, that is identification information representing a destination display device. A video type is information indicating the type of the video signal such as 3D video or 2D video. An effective data amount is information indicating the packet data amount. An error detection code is a code for error detection in the communication header, such as a cyclic redundancy check (CRC) code.

In a case of a 3D video signal, the packet distributing unit 122 distributes a right-eye signal to the downlink and a left-eye signal to the uplink to enable simultaneous delivery as illustrated in FIG. 2. Alternatively, the packet distributing unit 122 may distribute a right-eye signal to the uplink and a left-eye signal to the downlink.

The downlink packet is then output from the packet distributing unit 122 to the DL transmitting unit 123, and delivered from the DL transmitting unit 123 to the first display device 200 and the second display device 300 via the transmission path of DL1, DL2, and DL3. The uplink packet is output from the packet distributing unit 122 to the UL transmitting unit 125, and delivered from the UL transmitting unit 125 to the second display device 300 and the first display device 200 via the transmission path of UL1, UL2, and UL3.

Since the right-eye signal and the left-eye signal are transmitted simultaneously via the two transmission paths in this manner, the transmission efficiency and the transmission rate are improved as compared to a case where a right-eye signal and a left-eye signal are transmitted sequentially via one transmission path as in the conventional art.

In a case of a 2D video signal, the packet distributing unit 122 distributes the 2D video signal to the downlink and distributes a blank signal to the uplink as illustrated in FIG. 3. Alternatively, the packet distributing unit 122 may distribute the 2D video signal to the uplink and a blank signal to the downlink. Alternatively, the packet distributing unit 122 may distribute an identical 2D video signal to both of the uplink and the downlink. FIG. 3 illustrates an example in which the 2D video signal is delivered to the second display device 300 only.

The downlink packet is then output from the packet distributing unit 122 to the DL transmitting unit 123, and delivered from the DL transmitting unit 123 to the first display device 200 and the second display device 300 via the transmission path of DL1, DL2, and DL3.

The DL transmitting unit 123 and the UL transmitting unit 125 transmit packets of video signals corresponding to one horizontal line of video in synchronization with a horizontal synchronizing signal, so that no time lag occurs in reproducing video between the first display device 200 and the second display device 300.

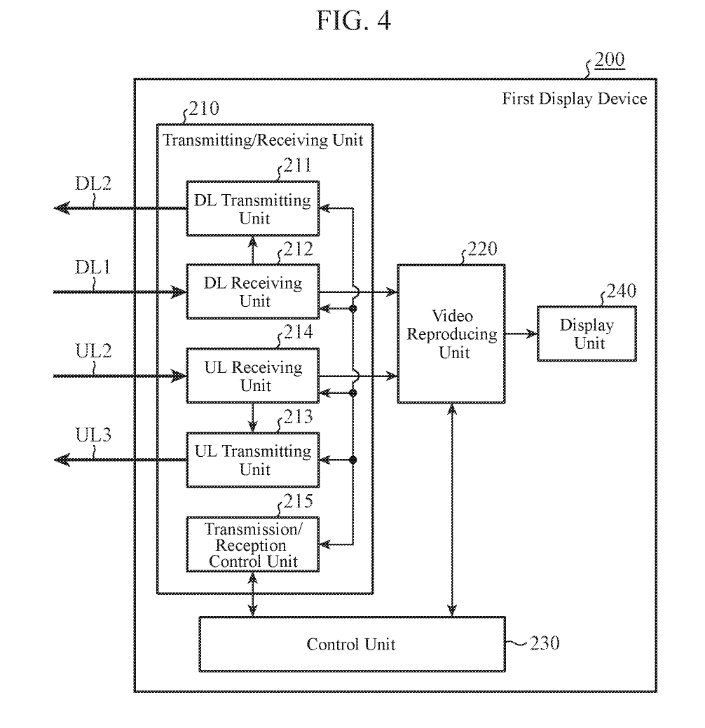

FIG. 4 is a block diagram illustrating an example configuration of the first display device 200. The first display device 200 includes a transmitting/receiving unit 210, a video reproducing unit 220, a control unit 230, and a display unit 240. Although not illustrated, the second display device 300 has a configuration similar to that of the first display device 200. In the following, an example of the first display device 200 is used for detailed description of a display device.

The first display device 200 is, for example, a display device for a meter to be mounted near a driver's seat of a vehicle, a display device for a navigation system to be mounted on a central area of the front seats, a display device for an RSE system to be mounted at the rear seats, or the like. Note that the application of the first display device 200 is not limited to use for vehicles, but may be used for any other purposes such as household use.

The transmitting/receiving unit 210 includes a DL transmitting unit 211, a DL receiving unit 212, an UL transmitting unit 213, an UL receiving unit 214, and a transmission/reception control unit 215.

The DL receiving unit 212 receives packets from the video delivery device 100 via the transmission path DL1, and outputs the packets to the DL transmitting unit 211. The DL transmitting unit 211 re-transmits the packets received from the DL receiving unit 212 to the second display device 300 via the transmission path DL2.

In addition, the DL receiving unit 212 outputs the communication headers in the received packets to the transmission/reception control unit 215 for analysis, and receives the result of the analysis from the transmission/reception control unit 215. The DL receiving unit 212 then captures only packets addressed to itself from among the received packets on the basis of the result of analysis of the communication headers, and outputs the captured packets to the video reproducing unit 220. The packet addressed to the self is #1 3D right-eye signal in FIG. 2, for example.

The UL receiving unit 214 receives packets from the second display device 300 via the transmission path UL2, and outputs the packets to the UL transmitting unit 213. The UL transmitting unit 213 re-transmits the packets received from the UL receiving unit 214 to the video delivery device 100 via the transmission path UL3.

In addition, the UL receiving unit 214 outputs the communication headers in the received packets to the transmission/reception control unit 215 for analysis, and receives the result of the analysis from the transmission/reception control unit 215. The UL receiving unit 214 then captures only packets addressed to itself from among the received packets on the basis of the result of analysis of the communication headers, and outputs the captured packets to the video reproducing unit 220. The packet addressed to the self is #1 3D left-eye signal in FIG. 2, for example.

The transmission/reception control unit 215 receives a communication header from the DL receiving unit 212 or the UL receiving unit 214, analyzes the communication header to determine whether or not the packet is addressed to itself, and outputs the result of the analysis to the DL receiving unit 212 or the UL receiving unit 214.

The transmission/reception control unit 215 also outputs information such as the video type obtained by analyzing of the communication header to the control unit 230.

The video reproducing unit 220 receives the packets from the DL receiving unit 212 and the UL receiving unit 214, and also receives the information such as the video type notified from the control unit 230. The video reproducing unit 220 then reproduces the video signals from the packets on the basis of the information such as the video type, and outputs the reproduced video signals to the display unit 240. The display unit 240 is a display that receives and displays the video signals from the video reproducing unit 220. In a case where the video type is 3D, the video reproducing unit 220 outputs the right-eye signal of the downlink and the left-eye signal of the uplink to the display unit 240. In a case where the video type is 2D, the video reproducing unit 220 outputs the 2D signal of the downlink or the uplink to the display unit 240.

Note that the control unit 230 generates internal reference clocks on the basis of the timings at which packets are transmitted from the video delivery device 100 via the downlink and uplink transmission paths with a period of the horizontal synchronizing signal. The control unit 230 thus uses the internal reference clocks to control timing at which the transmitting/receiving unit 210 transmits or receives a video signal and horizontal synchronization timing at which the video reproducing unit 220 displays a video signal on the display unit 240.

In addition, the DL transmitting unit 211 and the UL transmitting unit 213 may each add identification information unique to each display device to which the units 211 and 213 belong, to the received packets before re-transmission of the packets. Furthermore, in a case where the DL receiving unit 212 or the UL receiving unit 214 fails to receive a packet owing to occurrence of an abnormality or a fault in a transmission path, the DL transmitting unit 211 or the UL transmitting unit 213 may re-transmit a packet containing the identification information and a blank signal The identification information is used for fault determination of a ring network in a second embodiment, which will be described later.

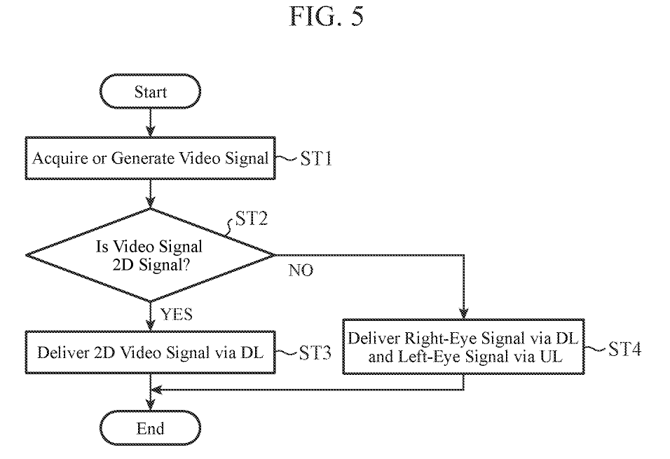

Next, operation of the video delivery device 100 will be explained with reference to a flowchart of FIG. 5.

In step ST1, the video acquiring unit 111 of the video acquiring/generating unit 110 acquires a 2D or 3D video signal from an external device or the video generating unit 112 thereof generates a 2D or 3D video signal, and outputs the 2D or 3D video signal to the transmitting/receiving unit 120.

In step ST2, the packet generating unit 121 of the transmitting/receiving unit 120 receives the video signal from the video acquiring/generating unit 110, adds a communication header, and packetizes the video signal. The packet distributing unit 122 proceeds to step ST3 if the packetized video signal is a 2D video signal (step ST2 “YES), or proceeds to step ST4 if the packetized video signal is a 3D video signal (step ST2 “NO”).

In step ST3, the packet distributing unit 122 outputs the packetized 2D video signal and communication header to the DL transmitting unit 123. The DL transmitting unit 123 delivers the packetized 2D video signal and communication header to the first display device 200 and the second display device 300 via DL1, DL2, and DL3.

In step ST4, the packet distributing unit 122 outputs the packetized right-eye signal, which is a 3D video signal, and communication header to the DL transmitting unit 123. The DL transmitting unit 123 delivers the packetized right-eye signal and communication header to the first display device 200 and the second display device 300 via DL1, DL2, and DL3.

The packet distributing unit 122 also outputs the packetized left-eye signal, which is a 3D video signal, and communication header to the UL transmitting unit 125. The UL transmitting unit 125 delivers the packetized left-eye signal and communication header to the second display device 300 and the first display device 200 via UL1, UL2, and UL3.

As described above, the video delivery device 100 according to the first embodiment has a configuration including the video acquiring/generating unit 110 for acquiring or generating a 2D or 3D video signal, and the transmitting/receiving unit 120 for transmitting and receiving a video signal to/from the first display device 200 and the second display device 300 connected via the ring network. The transmitting/receiving unit 120 includes the UL transmitting unit 125 and the UL receiving unit 126 for transmitting and receiving a video signal via the uplink of the ring network, and the DL transmitting unit 123 and the DL receiving unit 124 for transmitting and receiving a video signal via the downlink. In a case where a 2D video signal is transmitted and received, the DL transmitting unit 123 and the DL receiving unit 124 transmit and receive the 2D video signal. In a case where a 3D video signal is transmitted and received, the DL transmitting unit 123 and the DL receiving unit 124 transmit and receive a left-eye video signal, and the UL transmitting unit 125 and the UL receiving unit 126 transmit and receive a right-eye video signal. This allows improvement in the transmission efficiency and the transmission rate in delivery of 2D and 3D video signals to one or more display devices. In addition, the connection of the video delivery device 100, the first display device 200, and the second display device 300 via the ring network can reduce the cost for the transmission paths.

Furthermore, according to the first embodiment, the transmitting/receiving unit 120 has a configuration in which the identification information of a display device indicating the destination of the video signal is added to a video signal before transmission. This allows different video signals to be transmitted to different display devices.

Furthermore, according to the first embodiment, the transmitting/receiving unit 120 has a configuration in which respective video signals in units of one horizontal line to be displayed on the first display device 200 and the second display device 300 are transmitted within one horizontal line period of video. This allows synchronization of video display on one or more display devices.

### Second Embodiment

In the first embodiment described above, downlink and uplink packets delivered via the transmission paths are not used for video display by the video delivery device 100. Thus, packets received by the DL receiving unit 124 and the UL receiving unit 126 of the video delivery device 100 are discarded. In contrast, in the second embodiment, such packets are used for fault diagnosis of a video delivery system to improve the quality of transmission.

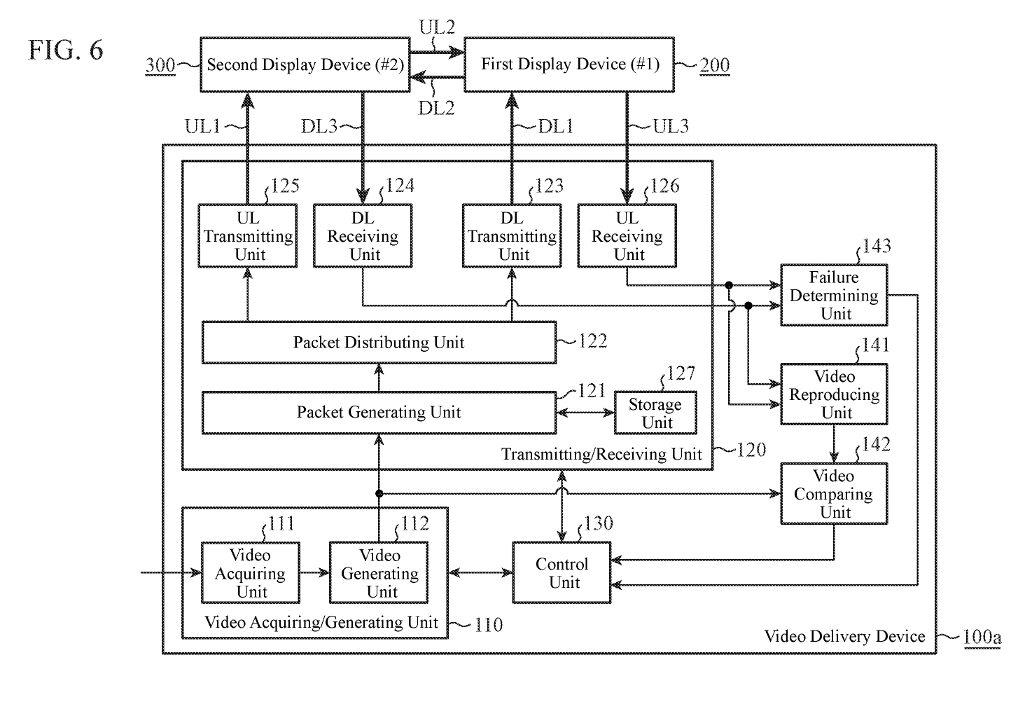

FIG. 6 is a block diagram illustrating an example configuration of a video delivery system according to the second embodiment of the present invention. The video delivery system includes a video delivery device 100a, and a first display device 200 and a second display device 300 in wired connection with the video delivery device 100a via a ring network. In FIG. 6, parts that are the same as or corresponding to those in FIGS. 1 and 4 will be designated by the same reference numerals, and the description thereof will not be repeated.

The video delivery device 100a according to the second embodiment includes a video reproducing unit 141, a video comparing unit 142, and a fault determining unit 143, so as to perform fault diagnosis of the video delivery system. In addition, the video delivery device 100a includes a storage unit 127 from/to which the packet generating unit 121 can read/write data. The packet generating unit 121 temporarily stores a generated packet in the storage unit 127 for a case where re-transmission of the packet is required.

The video reproducing unit 141 acquires a packet transmitted from the DL transmitting unit 123 and received by the DL receiving unit 124 via DL1, DL2, and DL3, reproduces a video signal from the packet, and outputs the video signal to the video comparing unit 142. The video reproducing unit 141 also acquires a packet transmitted from the UL transmitting unit 125 and received by the UL receiving unit 126 via UL1, UL2, and UL3, reproduces a video signal from the packet, and outputs the video signal to the video comparing unit 142.

The video comparing unit 142 acquires a video signal before being delivered, which is acquired or generated by the video acquiring/generating unit 110. The video comparing unit 142 also acquires the video signal after being delivered, which is reproduced by the video reproducing unit 141. The video comparing unit 142 then compares the video signals in units of one horizontal line before and after being delivered, detects a difference therebetween, and outputs the result of the comparison to the control unit 130. When a difference is present between the video signals before and after being delivered, an abnormality or a fault may have occurred in any of the transmission paths DL1, DL2, DL3, UL1, UL2, and UL3.

When a comparison result indicating the presence of the difference is received from the video comparing unit 142, the control unit 130 outputs an instruction to the transmitting/receiving unit 120 to re-transmit the video signal from which the difference is detected. Upon receiving the re-transmission instruction from the control unit 130, the packet generating unit 121 of the transmitting/receiving unit 120 reads out the packet to be re-transmitted, from the storage unit 127, and outputs the packet to the packet distributing unit 122. The packet distributing unit 122 distributes the packet received from the packet generating unit 121 to the DL transmitting unit 123 or the UL transmitting unit 125 for re-transmission.

For example, when a difference is detected in the #1 3D right-eye signal illustrated in FIG. 2 between before and after delivery, the transmitting/receiving unit 120 re-transmits the #1 communication header and the #1 3D right-eye signal subsequently to transmission of the #2 3D right-eye signal within the same one horizontal line period of video. This improves the quality of transmission of video signals.

The fault determining unit 143 acquires a packet transmitted from the DL transmitting unit 123 and received by the DL receiving unit 124 via DL1, DL2, and DL3, and a packet transmitted from the UL transmitting unit 125 and received by the UL receiving unit 126 via UL1, UL2, and UL3. The fault determining unit 143 then determines a fault of the video delivery system on the basis of the packets, and outputs the result of the determination to the control unit 130.

Note that the DL transmitting units 211 and the UL transmitting units 213 of the first display device 200 and the second display device 300 re-transmit the received packets with the identification information unique to each display device to which the units 211 and 213 belong, as described in the first embodiment. In addition, in a case where the DL receiving unit 212 or the UL receiving unit 214 fails to receive a packet owing to occurrence of an abnormality or a fault in a transmission path, the DL transmitting unit 211 or the UL transmitting unit 213 re-transmits a packet containing the identification information and a blank signal.

For example, assume a case where the video delivery device 100a transmits and receives the packets of the 3D video signals illustrated in FIG. 2. In this case, if a cable of DL1 is disconnected, the first display device 200 cannot receive a packet from the video delivery device 100a at the timing of the horizontal synchronizing signal. Thus, the first display device 200 re-transmits a packet containing its own identification information (#1) and the blank signal to the second display device 300 via DL2. The second display device 300 receives the packet containing the identification information of #1 and the blank signal from the first display device 200 via DL2, adds its own identification information (#2) to the packet and re-transmits the packet. The DL receiving unit 124 of the video delivery device 100a receives the packet containing the identification information of #1 and #2 and the blank signal from the second display device 300 via DL3. The fault determining unit 143 determines that a fault is present in DL1 since the packet received from the DL receiving unit 124 contains the identification information of #1 and #2 but contains no video signal, and notifies the control unit 130 of its determination result. Upon receiving the notification, the control unit 130 determines that the downlink cannot be used, outputs an instruction to the video generating unit 112 to convert the video signal for the first display device 200 and the video signal for the second display device 300 from 3D video signals into 2D video signals, and an instruction to the packet distributing unit 122 to use only the uplink. As a result, the 2D video signals are delivered from the video delivery device 100a to the first display device 200 and the second display device 300 via the uplink.

If a cable of DL2 is disconnected in the case where the video delivery device 100a transmits and receives packets of the 3D video signals illustrated in FIG. 2, the second display device 300 cannot receive a packet from the first display device 200 at the timing of the horizontal synchronizing signal. Thus, the second display device 300 re-transmits a packet containing its own identification information (#2) and a blank signal to the video delivery device 100a via DL3. The DL receiving unit 124 of the video delivery device 100a receives the packet containing the identification information of #2 and the blank signal from the second display device 300 via DL3. The fault determining unit 143 determines that a fault is present in DL2 since the packet received from the DL receiving unit 124 contains the identification information of #2 but contains no video signal, and notifies the control unit 130 of its determination result. Upon receiving the notification, the control unit 130 determines that video delivery can be performed to the first display device 200 via the downlink but cannot be performed to the second display device 300. The control unit 130 then outputs an instruction to the video generating unit 112 to convert the video signal for the second display device 300 from a 3D video signal into a 2D video signal, and an instruction to the uplink to the packet distributing unit 122 to distribute the 2D video signal for the second display device 300. As a result, a 3D video signal is continuously delivered from the video delivery device 100a to the first display device 200 via DL1 and via UL1 and UL2.

Meanwhile, a 2D video signal is delivered from the video delivery device 100a to the second display device 300 via UL1.

If a cable DL3 is disconnected in the case where the video delivery device 100a transmits and receives packets of the 3D video signals illustrated in FIG. 2, the DL receiving unit 124 of the video delivery device 100a cannot receive a packet from the second display device 300 at the timing of the horizontal synchronizing signal. In this case, the fault determining unit 143 determines that a fault is present in DL3, and notifies the control unit 130 of its determination result. Even if a fault is present in DL3, however, packets can be transmitted to the first display device 200 and the second display device 300 via DL1 and DL2. Thus, the control unit 130 determines to continue the delivery. The delivery of 3D video signals to the first display device 200 and the second display device 300 is therefore continued.

As described above, when a fault such as disconnection of a cable of the downlink occurs during delivery of 3D video, although it is different from the 3D video to be originally delivered, display of video on the first display device 200 and the second display device 300 can be continued. This improves the quality of the whole video delivery system.

Although not described, fault determination and switching of delivery can also be performed for the uplink similarly to the downlink.

Next, assume a case where the video delivery device 100a transmits and receives packets of 2D video signals via the downlink. If a cable of any of DL1, DL2, and DL3 is disconnected in this case, a packet whose content is different from that of the delivered packet is received by the DL receiving unit 124 of the video delivery device 100a as described above. Upon determining that a fault is present in the downlink on the basis of the packet received by the DL receiving unit 124, the fault determining unit 143 notifies the control unit 130 of its determination result. The control unit 130 in receipt of the notification outputs an instruction to the packet distributing unit 122 to distribute a 2D video signal for the first display device 200 and a 2D video signal for the second display device 300 to the uplink. As a result, delivery of the 2D video signals from the video delivery device 100a to the first display device 200 and the second display device 300 via the uplink is continued.

As described above, when a fault such as disconnection of a cable of the downlink occurs during delivery of 2D video, display of video on the first display device 200 and the second display device 300 can be continued through normal uplink cables. This improves the quality of the whole video delivery system.

Although not described, fault determination and switching of delivery can also be performed for the uplink similarly to the downlink.

While the video delivery device 100a includes all of the video reproducing unit 141, the video comparing unit 142, and the fault determining unit 143 in the example of FIG. 6, the video delivery device 100a may include the video reproducing unit 141 and the video comparing unit 142 only or include the fault determining unit 143 only.

As described above, the video delivery device 100a according to the second embodiment includes the video comparing unit 142 for comparing a video signal before being transmitted to the first display device 200 and the second display device 300 with the video signal after being received from the first display device 200 and the second display device 300, and detects a difference therebetween. In addition, the transmitting/receiving unit 120 is configured to re-transmit the video signal from which the difference is detected by the video comparing unit 142. This improves the quality of the video delivery system.

In addition, the video delivery device 100a according to the second embodiment includes the fault determining unit 143 for determining a fault in the ring network by using information transmitted when the first display device 200 or the second display device 300 could not receive a video signal. In addition, the video acquiring/generating unit 110 is configured to convert a 3D video signal into a 2D video signal when a fault is determined by the fault determining unit 143 during transmission/reception of the 3D video signal by the transmitting/receiving unit 120. Furthermore, the transmitting/receiving unit 120 is configured to transmit and receive the 2D video signal obtained by the conversion by the video acquiring/generating unit 110. This improves the quality of the video delivery system.

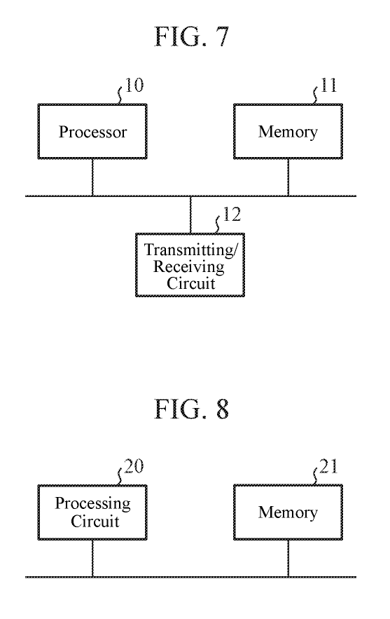

Finally, example hardware configurations of the video delivery devices 100 and 100a according to the embodiments of the present invention will be described with reference to FIGS. 7 and 8.

The transmitting/receiving unit 120 in the video delivery devices 100 and 100a is a transmitting/receiving circuit 12 illustrated in FIG. 7. The video acquiring/generating unit 110, the control unit 130, the video reproducing unit 141, the video comparing unit 142, and the fault determining unit 143 in the video delivery devices 100 and 100a are a processor 10 for executing programs stored in a memory 11. The processor 10 may be referred to as a central processing unit (CPU), a processing unit, a computing unit, a microprocessor, a microcomputer, a digital signal processor (DSP) or the like. In addition, the storage unit 127 in the video delivery device 100a is the memory 11 illustrated in FIG. 7.

When the video delivery devices 100 and 100a have the hardware configuration illustrated in FIG. 7, the functions of the video acquiring/generating unit 110, the control unit 130, the video reproducing unit 141, the video comparing unit 142, and the fault determining unit 143 are implemented by software, firmware, or combination of software and firmware. The software or firmware is described in the form of programs and stored in the memory 11. The processor 10 implements the functions of the respective units by reading and executing the programs stored in the memory 11. Thus, the video delivery devices 100 and 100a include the memory 11 for storing programs to be executed by the processor 10, which results in execution of the steps illustrated in FIG. 5. Note that these programs can also be deemed to cause a computer to execute the procedures or methods of the respective units of the video delivery devices 100 and 100a.

The memory 11, and a memory 21, which will be described later, may be nonvolatile or volatile semiconductor memories such as random access memories (RAMs), read only memories (ROMs), flash memories, erasable programmable ROMs (EPROMs), or electrically EPROMs (EEPROMs), magnetic disks such as hard disks, or flexible disks, or optical disks such as mini discs, compact discs (CDs), or digital versatile discs (DVDs), for example, and are preferably RAMs allowing fast access.

In the example hardware configuration illustrated in FIG. 8, the video acquiring/generating unit 110, the transmitting/receiving unit 120, the control unit 130, the video reproducing unit 141, the video comparing unit 142, and the fault determining unit 143 of the video delivery devices 100, 100a are a processing circuit 20. In addition, the storage unit 127 in the video delivery device 100a is the memory 21 illustrated in FIG. 8.

When the video delivery devices 100 and 100a have the hardware configuration illustrated in FIG. 8, the processing circuit 20 may be a single circuit, a composite circuit, a programmed processor, a parallel-programmed processor, an application specific integrated circuit (ASIC), a field programmable gate array (FPGA), or a combination thereof, for example. The functions of the respective units of the video delivery devices 100 and 100a may be implemented by a plurality of processing circuits 20, or may be integrated into one processing circuit 20.

Alternatively, some of the functions of the respective units of the video delivery devices 100 and 100a may be implemented by the processing circuit 20, which is dedicated hardware, and others may be implemented by software or firmware. As described above, the functions of the respective units of the video delivery devices 100 and 100a are implemented by hardware, software, firmware, or combination thereof.

The embodiments of the present invention can be freely combined, any components in the embodiments can be modified, and any components in the embodiments can be omitted within the scope of the invention.

### INDUSTRIAL APPLICABILITY

A video delivery system according to the present invention delivers video to one or more display devices connected via a ring network, which is suitable for use as a video delivery system used in an RSE system or the like having one or more display devices in a vehicle, for example.

### REFERENCE SIGNS LIST

10: processor, 11, 21: memory, 12: transmitting/receiving circuit, 20: processing circuit, 100: video delivery device, 110: video acquiring/generating unit, 111: video acquiring unit, 112: video generating unit, 120: transmitting/receiving unit, 121: packet generating unit, 122: packet distributing unit, 123: DL transmitting unit, 124: DL receiving unit, 125: UL transmitting unit, 126: UL receiving unit, 127: storage unit, 130: control unit, 141: video reproducing unit, 142: video comparing unit, 143: fault determining unit, 200: first display device, 210: transmitting/receiving unit, 211: DL transmitting unit, 212: DL receiving unit, 213: UL transmitting unit, 214: UL receiving unit, 215: transmission/reception control unit, 220: video reproducing unit, 230: control unit, 240: display unit, 300: second display device

1. A video delivery device comprising:
a video acquiring/generating unit to acquire or generate a two-dimensional or three-dimensional video signal; and
a transmitting/receiving unit to transmit and receive the video signal to/from one or more display devices connected via a ring network, wherein
the transmitting/receiving unit includes an uplink transmitting/receiving unit to transmit and receive a video signal via an uplink of the ring network and a downlink transmitting/receiving unit to transmit and receive a video signal via a downlink of the ring network,
for transmitting/receiving a two-dimensional video signal, the transmitting/receiving unit transmits/receives the two-dimensional video signal via either one or both of the uplink transmitting/receiving unit and the downlink transmitting/receiving unit, and
for transmitting/receiving a three-dimensional video signal, the transmitting/receiving unit transmits/receives a right-eye video signal via any one of the uplink transmitting/receiving unit or the downlink transmitting/receiving unit, and transmits/receives a left-eye video signal via another one of the uplink transmitting/receiving unit or the downlink transmitting/receiving unit.

2. The video delivery device according to claim 1, wherein the transmitting/receiving unit adds identification information of the display device representing destination of a video signal to the video signal and transmits the video signal.

3. The video delivery device according to claim 1, wherein the transmitting/receiving unit transmits respective video signals in units of one horizontal line to be displayed on the one or more display devices within a period during which the one or more display devices display the video signals in units of one horizontal line.

4. The video delivery device according to claim 1, further comprising:
a video comparing unit to compare a video signal before being transmitted to the one or more display devices with the video signal after being received from the one or more display devices, and detect a difference therebetween, wherein
the transmitting/receiving unit re-transmits a video signal from which a difference is detected by the video comparing unit.

5. The video delivery device according to claim 1, further comprising:
a fault determiner to determine a fault in the ring network by using information transmitted by the display device when the display device fails to receive a video signal, wherein
when a fault is determined to be present by the fault determiner during transmission/reception of a three-dimensional video signal by the transmitting/receiving unit, the video acquiring/generating unit converts the three-dimensional video signal into a two-dimensional video signal, and
the transmitting/receiving unit transmits/receives the two-dimensional video signal obtained by conversion by the video acquiring/generating unit.

6. A video delivery system comprising:
one or more display devices connected via a ring network; and a video delivery device including a video acquiring/generating unit to acquire or generate a two-dimensional or three-dimensional video signal, and a transmitting/receiving unit to transmit and receive the video signal to/from the one or more display devices, wherein
the transmitting/receiving unit includes an uplink transmitting/receiving unit to transmit and receive a video signal via an uplink of the ring network and a downlink transmitting/receiving unit to transmit and receive a video signal via a downlink of the ring network,
for transmitting/receiving a two-dimensional video signal, the transmitting/receiving unit transmits/receives the two-dimensional video signal via either one or both of the uplink transmitting/receiving unit and the downlink transmitting/receiving unit, and
for transmitting/receiving a three-dimensional video signal, the transmitting/receiving unit transmits/receives a right-eye video signal via any one of the uplink transmitting/receiving unit or the downlink transmitting/receiving unit, and transmits/receives a left-eye video signal via another one of the uplink transmitting/receiving unit and the downlink transmitting/receiving unit.

7. A video delivery method for a video delivery device to transmit/receive a video signal to/from one or more display devices connected via a ring network, the video delivery method comprising:
acquiring or generating a two-dimensional or three-dimensional video signal by a video acquiring/generating unit;
transmitting/receiving a two-dimensional video signal via either one or both of an uplink and a downlink of the ring network by a transmitting/receiving unit when the video acquiring/generating unit has acquired or generated the two-dimensional video signal; and
transmitting/receiving a right-eye video signal via any one of the uplink or the downlink of the ring network and a left-eye video signal via another one of the uplink or the downlink by the transmitting/receiving unit when the video acquiring/generating unit has acquired or generated a three-dimensional video signal.
